(19) United States
(12) Patent Application Publication
(10) Pub. No.: US 2024/0273397 A1
(43) Pub. Date: Aug. 15, 2024

(54) MACHINE LEARNING MODEL LINEAGE TRACKING

(71) Applicant: Microsoft Technology Licensing, LLC, Redmond, WA (US)

(72) Inventors: Deepak NARAYANAN, Bellevue, WA (US); Amar PHANISHAYEE, Seattle, WA (US); Daniel Marcos MENDOZA, Stanford, CA (US); Wei HAO, New York City, NY (US)

(21) Appl. No.: 18/144,565

(22) Filed: May 8, 2023

Related U.S. Application Data
(60) Provisional application No. 63/445,600, filed on Feb. 14, 2023.

(51) Int. Cl. G06N 20/00

(52) U.S. Cl. CPC G06N 20/00

(57) ABSTRACT

The present disclosure relates to methods and systems that create a lineage graph that tracks provenance information across machine learning models. The methods and systems use the lineage graph to facilitate machine learning model testing, diagnostics, and updating. The methods and system also use the lineage graph to determine a storage optimization for reducing a storage footprint of the machine learning models.

### CROSS-REFERENCE TO RELATED APPLICATIONS

This application claims priority to and the benefit of U.S. Provisional Patent Application No. 63/445,600, filed on Feb. 14, 2023, which is hereby incorporated by reference in its entirety.

### BACKGROUND

Machine learning model derivatives are extremely common in machine learning (ML) today. For example, a commonly used paradigm in ML is “pre-training models” on large amounts of possibly unlabeled data in a self-supervised fashion and then finetuning these ML models on specific tasks as needed. Similarly, specializing ML models for edge devices for memory and compute reasons has also become common. This has led to an ecosystem where ML models are related to each other, sharing structure and often even parameter values.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes identifying a plurality of machine learning models. The method includes determining provenance information for each machine learning model of the plurality of machine learning models. The method includes generating, using the provenance information, a lineage graph with a plurality of nodes and a plurality of provenance edges, wherein the plurality of nodes correspond to the plurality of machine learning models and a provenance edge between two nodes indicates a node is derived from another node.

Some implementations relate to a device. The device includes a processor; memory in electronic communication with the processor; and instructions stored in the memory, the instructions being executable by the processor to: identify a plurality of machine learning models; determine provenance information for each machine learning model of the plurality of machine learning models; and generate, using the provenance information, a lineage graph with a plurality of nodes and a plurality of provenance edges, wherein the plurality of nodes correspond to the plurality of machine learning models and a provenance edge between two nodes indicates a node is derived from another node.

Some implementations relate to a method. The method includes obtaining a lineage graph with a plurality of nodes and a plurality of provenance edges, wherein each node of the plurality of nodes corresponds to a machine learning model and a provenance edge between two nodes indicates a machine learning model is derived from another machine learning model. The method includes performing a traversal of the lineage graph. The method includes applying, in response to the traversal, a function to a node of the plurality of nodes. The method includes using the provenance edge of the node to identify another node connected to the node. The method includes automatically applying the function to the other node.

Some implementations relate to a device. The device includes a processor; memory in electronic communication with the processor; and instructions stored in the memory, the instructions being executable by the processor to: obtain a lineage graph with a plurality of nodes and a plurality of provenance edges, wherein each node of the plurality of nodes corresponds to a machine learning model and a provenance edge between two nodes indicates a machine learning model is derived from another machine learning model; perform a traversal of the lineage graph; apply, in response to the traversal, a function to a node of the plurality of nodes; use the provenance edge of the node to identify another node connected to the node; and automatically apply the function to the other node.

Some implementations relate to a method. The method includes obtaining a lineage graph with a plurality of nodes and a plurality of provenance edges, wherein each node of the plurality of nodes corresponds to a machine learning model and a provenance edge between two nodes indicates a machine learning model is derived from another machine learning model. The method includes using the lineage graph to determine a storage optimization for generating a compressed lineage graph.

Some implementations relate to a device. The device includes a processor; memory in electronic communication with the processor; and instructions stored in the memory, the instructions being executable by the processor to: obtain a lineage graph with a plurality of nodes and a plurality of provenance edges, wherein each node of the plurality of nodes corresponds to a machine learning model and a provenance edge between two nodes indicates a machine learning model is derived from another machine learning model; and use the lineage graph to determine a storage optimization for generating a compressed lineage graph.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims.

Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for use with lineage graphs in accordance with implementations of the present disclosure.

FIG. 2 illustrates an example lineage graph in accordance with implementations of the present disclosure.

FIG. 3 illustrates an example method for creating a lineage graph in accordance with implementations of the present disclosure.

FIG. 4 illustrates an example method for using the lineage graph to perform a function in accordance with implementations of the present disclosure.

FIG. 5 illustrates an example method for using the lineage graph to perform a storage optimization in accordance with implementations of the present disclosure.

### DETAILED DESCRIPTION

Machine learning model derivatives are extremely common in machine learning (ML) today. Machine learning model derivatives are machine learning models that are created that depend on each other. For example, a commonly used paradigm in ML is “pre-training models” on large amounts of possibly unlabeled data in a self-supervised fashion and then finetuning these ML models on specific tasks as needed. Similarly, specializing ML models for edge devices for memory and compute reasons has also become common. This has led to an ecosystem where ML models are related to each other, sharing structure and often even parameter values.

However, it is hard to manage these ML model derivatives. Systems today are unable to facilitate tracking provenance information across ML models, which can be useful for model debugging and automated updating. Additionally, the storage overhead of storing all derived ML models is onerous, prompting users to get rid of intermediate models that might be useful for further analysis.

The methods and systems of the present disclosure track lineage information across machine learning models. The methods and system use a lineage graph abstraction for machine learning models. The lineage graph helps track provenance information across multiple machine learning models. Edges in the lineage graph track how the machine learning models are related to each other. Nodes in the lineage graph (the machine learning models) can be annotated with other information such as, creation functions, to allow for automated updating of nodes in response to updates upstream. In some implementations, the lineage graph stores other metadata, such as, test functions, that may be used for monitoring the machine learning models.

In some implementations, the lineage graphs are created automatically from already trained model checkpoints, using a diff primitive which quantitatively measures the difference between two models in terms of both operator connectivity within each model and parameter values. In some implementations, the lineage graphs are manually created using an add command provided by a user.

The lineage graph abstraction also supports efficient storage of model checkpoints, which can become large. In some implementations, the methods and systems leverage two techniques (content-based hashing and delta compression) to reduce the storage footprint of the machine learning models. Model parameters shared among multiple machine learning models can be de-duplicated using content-based hashing, and small changes in model parameters across machine learning models can be compressed efficiently with low runtime overhead and negligible accuracy loss. The combination of these techniques may lead to a significant reduction in storage footprint of the machine learning models compared to the baseline of storing each checkpoint independently. In some implementations, the storage reduction is seven times smaller as compared to the baseline of storing each checkpoint independently.

The methods and systems use the lineage graph to facilitate machine learning model testing, diagnostics, and/or updating. The lineage graph can be used to keep track of dependency information across fine-tuned machine learning models, machine learning models created using federated learning, and also machine learning models specialized for edge devices. Once constructed, the lineage graph may be used to test machine learning models and perform diagnostics using a traversal of the lineage graph. The traversal of the lineage graph can also be used to automatically update machine learning models given upstream updates.

The systems and methods enable functionality that is difficult to perform without a machine learning model management system. One technical advantage of the systems and methods of the present disclosure is storage optimizations collectively spanning multiple machine learning models. Another technical advantage of the systems and methods of the present disclosure is using the lineage graph to automatically update machine learning models with upstream updates. For example, the systems and methods use the lineage graph to automatically propagate a fix of machine learning model (e.g., a bug fix). Another technical advantage of the systems and method of the present disclosure is using the lineage graph to test or evaluate multiple machine learning models and perform differential analyses.

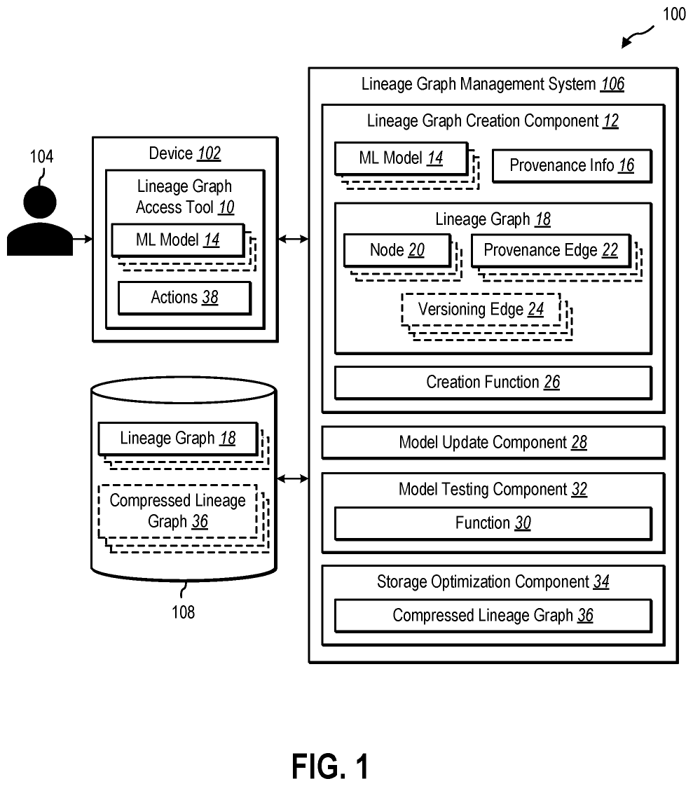

Referring now to FIG. 1, illustrated is an example environment 100 for use with lineage graphs 18. The lineage graph 18 is a directed graph where the machine learning models 14 are nodes of the graph and edges of the graph track provenance/versioning information between the machine learning models 14. The lineage graphs 18 also track other metadata, such as the machine learning model type and the machine learning model name, which is useful in testing machine learning models, updating machine learning models, and providing handles to changes the lineage graphs 18.

The environment 100 includes a lineage graph management system 106 that creates lineage graphs 18 and interacts with the lineage graphs 18. The lineage graph management system 106 includes a lineage graph creation component 12 that creates the lineage graphs 18 using a plurality of machine learning models 14 and provenance information 16 for the machine learning models 14. The provenance information 16 provides parent information of machine learning models that were used in creating the machine learning model. In some implementations, the provenance information 16 is automatically determined by the lineage graph creation component 12. For example, the lineage graph creation component 12 uses the graph difference algorithm to automatically determine the provenance information 16. In some implementation, the provenance information 16 is manually determined by manually adding nodes 20 to the lineage graph 18.

The lineage graph 18 includes multiple nodes 20. Each node corresponds to an individual machine learning model 14. Each node has an optional creation function 26 that tracks the creation of the machine learning model 14 from the parents of the machine learning model 14 and other relevant metadata, such as, model type, and a name. The creation function 26 has arguments corresponding to each of the node's 20 provenance parents.

The edges (the provenance edges 22 and the versioning edges 24) in the lineage graph 18 track the provenance information 16 and versioning information between machine learning models 14. The provenance edge 22 is an edge between a machine learning model 14 and machine learning model(s) 14 derived from the machine learning model. The provenance edge 22 tracks how the machine learning models 14 are created and the provenance edge 22 can be traversed to update the machine learning models 14 when an upstream machine learning model 14 is modified. The versioning edge 24 is an edge between two consecutive versions of the same machine learning model 14. The versioning edge 24 is used to track updates to a machine learning model 14 and may be queried, for example, to run tests on all versions of a given machine learning model 14.

In some implementations, the lineage graph creation component 12 automatically generates the lineage graph 18. A lineage graph 18 is created automatically from already trained model checkpoints, using a diff primitive which quantitatively measures the difference between two models in terms of both operator connectivity within each model and parameter values. The automated mode enables the lineage graph creation component 12 to automatically extract model dependency and node provenance information 16 for a user-specified machine learning model 14. The automated mode can speed up construction of the lineage graph 18 from a group of provided machine learning models 14.

The lineage graph 18 is stored in a datastore 108. In some implementations, the lineage graph is stored with adjacency lists. For each edge type (e.g., provenance edge 22 or versioning edge 24) in the lineage graph 18, every node 20 has a list of adjacent child nodes and a list of adjacent parent nodes.

In some implementations, a storage optimization component 34 incorporates storage optimizations to more efficiently store model parameters in the lineage graph 18 to generate a compressed lineage graph 36. In some implementations, the storage optimization component 34 uses content-based hashing to store parameters shared across models efficiently. The storage optimization component can also compress the differences between non-shared parameters of parent and child models efficiently. If the compression results in storage saving and compression does not result in an accuracy drop of the machine learning model 14, each delta-compressed parameter is stored on the datastore 108 as the compressed delta along with a pointer to the parent layer to facilitate future decompression (e.g., the compressed lineage graph 36). If compression does not result in storage savings or the accuracy drops of the machine learning model 14, compression is rejected, and the uncompressed model is persisted in the datastore 108 (e.g., the lineage graph 18).

The environment 100 also includes one or more devices 102 that one or more users 104 access. The device(s) 102 include a lineage graph access tool 10 that the user(s) 104 access to interact with the lineage graph management system 106. In some implementations, the lineage graph management system 106 is on a server (e.g., a cloud server) remote from the device 102 (e.g., at a server or other computing device) and the lineage graph access tool 10 communicates with lineage graph management system 106 via a network. The network may include one or multiple networks that use one or more communication platforms or technologies for transmitting data. For example, the network may include the Internet or other data link that enables transport of electronic data between respective devices of the environment 100.

In some implementations, the lineage graph access tool 10 is local to the device 102. One example includes the lineage graph access tool 10 is accessed using a command-line interface on the device 102. In some implementations, the lineage graph access tool 10 is on a server (e.g., a cloud server) remote from the device 102 accessed, for example, using a web browser on the device 102 via the network.

In some implementations, the user 104 uses the lineage graph access tool 10 to identify machine learning models 14 to include in a lineage graph 18. For example, the user 104 downloads pre-trained machine learning models from the internet or has pre-existing trained machine learning models on the device 102.

In some implementations, the user 104 uses the lineage graph access tool 10 to access the lineage graphs 18 created by the lineage graph management system 106 and perform one or more actions 38 on the lineage graphs 18. In some implementations, the actions 38 change or modify the lineage graphs 18. In some implementations, the actions 38 use the lineage graphs 18 to perform a function 30 (e.g., per-model evaluation, and/or automated machine learning model updating).

In some implementations, the actions 38 are provided using application programming interfaces (API) to the lineage graph management system 106. The APIs include the actions 38 to access the lineage graph 18 and/or modify the lineage graph 18. In addition, the APIs include actions 38 to use the lineage graph 18 to perform one or more functions 30 on the lineage graph 18 (e.g., running a test, updating the models, and/or providing a bug fix).

One example action 38 includes an add node action. The add node action adds a model as a node 20 to the lineage graph 18 with a name. A creation function 26 may be optionally specified in the add node action.

Another example action 38 includes a creation function registration action for a node 20 that registers a creation function 26 for a node 20. The creation function 26 specifies how the machine learning model 14 is created from its parents (e.g., the machine learning models the machine learning model 14 is derived from). The creation function 26 can also be used to specify multi-task learning (MTL) using the machine learning models 14 of the lineage graph 18.

Another example action 38 includes a register test function action for a node 20 that registers a test with a name either for a specific machine learning model 14 or for machine learning models 14 of a specified type.

Another example action 38 includes an add provenance edge action that adds a provenance edge 22 between two nodes 20 in the lineage graph 18. If the two nodes 20 do not already exist in the lineage graph 18, the add provenance edge action calls the add node action to add the two nodes 20 to the lineage graph 18.

Another example action 38 includes an add version edge action that adds a versioning edge 24 between two nodes 20 in the lineage graph 18. The two nodes must have the same machine learning model type to add the versioning edge 24. If the two nodes 20 do not already exist in the lineage graph 18, the add versioning edge action calls the add node action to add the two nodes 20 to the lineage graph 18.

Another example action 38 includes a traversal action that returns an iterator of individual nodes 20, or a group of nodes 20 encountered in a traversal of the lineage graph 18. One example traversal is a breadth-first search (BFS). Another example traversal is a depth first search (DFS).

Another example action 38 includes a get next version action that returns the next version of a machine learning model 14 if it exists in the lineage graph 18.

Another example action 38 includes a run tests action that runs the registered tests matching the specified test. In some implementations, the specified test(s) are run on all nodes 20 in the lineage graph 18. In some implementations, the specified test(s) are run on a subset of the nodes 20 in the lineage graph 18.

Another example action 38 includes a run function action that runs a function 30 on nodes 20 in the lineage graph 18. In some implementations, the function 30 is run on all nodes 20 of the lineage graph 18. In some, implementations, the function 30 is run on a subset of the nodes 20 in the lineage graph 18.

Another example action 38 includes a run update cascade action that triggers an update cascade as a result of updating a machine learning model 14 of the lineage graph 18. The nodes 20 in the lineage graph 18 are visited once their parents are visited. In some implementations, a new machine learning model 14 is created based on the update using the creation function 26.

The lineage graph access tool 10 provides the user 104 an easy way to view the lineage graphs 18, run registered tests on the lineage graphs 18, perform diagnostics of the machine learning models 14, propagate a bug fix in the machine learning models 14, and/or update the machine learning models 14. In addition, the lineage graph access tool 10 provides the user 104 a way to access the lineage graph 18 while specifying a machine learning model's 14 creation function 26 (e.g., to specify that two models have “tied” weights and can be trained using multi-task learning (MTL)). In some implementations, to facilitate the lineage graph access tool 10, changes to the lineage graph 18 or metadata used in the lineage graph 18 are serialized to disk at the end of every operation, and de-serialized at the start of every operation (e.g., the actions 38).

In some implementations, the model update component 28 calls the creation function 26 corresponding to nodes that are connected through provenance edges 22 to the updated node. The model update component 28 performs a traversal of the lineage graph 18 to identify the nodes in the lineage graph with a provenance edge 22 to the node 20. One example traversal is a breadth-first search (BFS). Another example traversal is a depth first search (DFS).

In some implementations, the model testing component 32 applies a function 30 to a node 20 in the lineage graph 18 in response to receiving the action 38 from the lineage graph access tool 10. In some implementations, the model testing component 32 automatically applies the function 30 to nodes with provenance edge 22 connections to the node 20 or the other node. The model testing component 32 performs a traversal of the lineage graph 18 to identify the nodes in the lineage graph with a provenance edge 22 or a versioning edge 24 to the node 20. One example traversal is a breadth-first search (BFS). Another example traversal is a depth first search (DFS).

In some implementations, the model update component 28 automatically triggers the update cascade on downstream dependent machine learning models 14. For example, when a new version of a machine learning model 14 is created, the model update component 28 follows the provenance edges 22 in the lineage graph 18 to produce a new set of model versions for all of the machine learning model's 14 descendants.

The lineage graph 18 helps track provenance information 16 across multiple machine learning models 14 in the form of both dependency edges (e.g., the provenance edges 22 and the versioning edges 24), and the creation functions 26 that can be used to re-create a machine learning model 14 given the machine learning model 14 checkpoints of its parents. In some implementations, the lineage graph 18 also stores other metadata, such as, test functions that can be used for machine learning model 14 monitoring.

A wide set of applications may use the lineage graph 18 to facilitate model testing, diagnostics, and updating. For example, the lineage graph 18 is used to keep track of dependency information across fine-tuned machine learning models 14, machine learning models 14 created using federated learning, and also machine learning models 14 specialized for edge devices. Once constructed, the lineage graph 18 can be used to test models and perform diagnostics using a traversal of the lineage graph 18 and the traversal of the lineage graph 18 may also be used to automatically update models in the lineage graph 18 given upstream updates.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the lineage graph access tool 10, the lineage graph management system 106, and the datastore 108 are implemented wholly on the same computing device. Another example includes one or more subcomponents of the lineage graph access tool 10, the lineage graph management system 106, and/or the datastore 108 are implemented across multiple computing devices. Moreover, in some implementations, one or more subcomponent of the lineage graph access tool 10, the lineage graph management system 106, and/or the datastore 108 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor may be referred to as a central processing unit (CPU). In some implementations, a single processor is used. In some implementations, a combination of processors (e.g., an ARM and DSP) is used. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

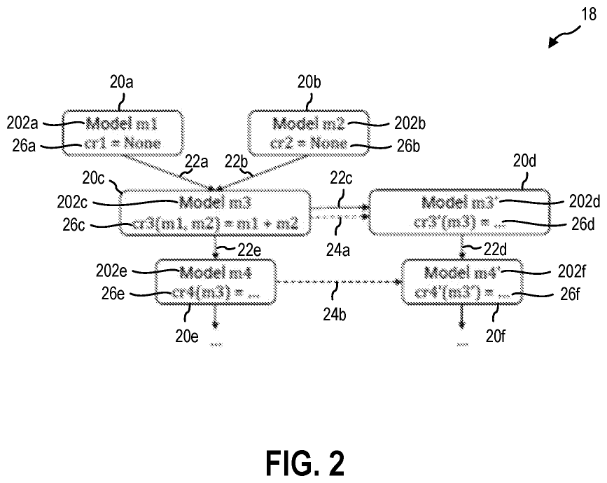

Referring now to FIG. 2, illustrated is an example lineage graph 18. The lineage graph 18 is created using the lineage graph creation component 12 (FIG. 1). The lineage graph 18 includes multiple nodes 20a, 20b, 20c, 20d, 20e, 20f, multiple provenance edges 22a, 22b, 22c, 22d, 22e, and multiple versioning edges 24a, 24b.

The node 20a includes a node name 202a “Model m1” and a creation function 26a. The creation function 26a indicates “none” since the node 20a is the parent node and is not derived from other machine learning models. The node 20b includes a node name 202b “Model m2” and a creation function 26b. The creation function 26b indicates “none” since the node 20b is a parent node and is not derived from other machine learning models.

A provenance edge 22a connects the node 20a to the node 20c and a provenance edge 22b connects the node 20b to the node 20c. The node 20c includes a node name 202c “Model m3” and a creation function 26c that indicates the ancestors for the node 20c are Model m1 (node 20a) and Mode m2 (node 20b). The creation function 26c also indicates how the Model m3 is created from the parent models (Model m1, Model m2). In the illustrated example, the creation function 26c indicates that the model m3 is the sum of the model m1 and the model m2.

A provenance edge 22c connects the node 20c to the node 20d. In addition, a versioning edge 24a connects the node 20c to the node 20d indicating that the node 20d is a version of the node 20c. The node 20d includes a node name 202d “Model m3′” and a creation function 26d. The creation function 26d indicates that Model m3′ is created from the parent model m3 and how the Model m3′ is created from the parent modelm3.

A provenance edge 22e also connects the node 20c to the node 20e. The node 20e includes a node name 202e “Model m4” and a creation function 26e. The creation function 26e indicates the Model m4 is created from the parent Model m3 and how the Model m4 is created from the parent Model m3.

A versioning edge 24b connects the node 20e to the node 20f indicating that the node 20f is a version of the node 20e. A provenance edge 22d connects the node 20f to the node 20d. The node 20f includes a node name 202f “Model m4′” and a creation function 26f that indicates the Model m4′ is created from the parent Model m4.

The lineage graph 18 provides a visual representation of the provenance information 16 among different machine learning models. In addition, the lineage graph 18 is used to facilitate machine learning model testing, machine learning model diagnostics, and/or updating of the machine learning models represented by the lineage graph 18.

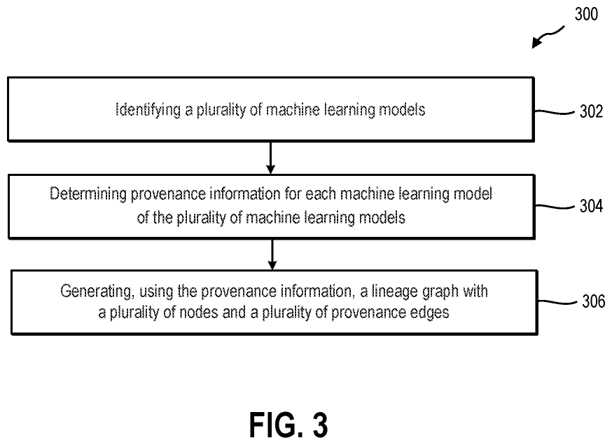

Referring now to FIG. 3, illustrated is an example method 300 for creating a lineage graph. The actions of the method 300 are discussed below with reference to FIGS. 1 and 2.

At 302, the method 300 includes identifying a plurality of machine learning models to include in a lineage graph. The lineage graph creation component 12 identifies a plurality of machine learning models 14 to include in the lineage graph 18. In some implementations, the plurality of machine learning models 14 include machine learning model derivatives that depend on another machine learning model. In some implementations, the lineage graph creation component 12 receives the identification of the machine learning models 14 from a lineage graph access tool 10. A user of the lineage graph access tool 10 provides an identification of the machine learning models 14 to include in the lineage graph 18. For example, the user 104 downloads pre-trained machine learning models from the internet or has pre-existing trained machine learning models on the device 102.

At 304, the method 300 includes determining provenance information for each machine learning model of the plurality of machine learning models. The lineage graph creation component 12 determines the provenance information 16 of the machine learning models 14. In some implementations, the provenance information 16 provides parent information of machine learning models that were used in creating the machine learning model 14. In some implementations, the user 104 provides the provenance information 16 for the machine learning models 14.

At 306, the method 300 includes generating, using the provenance information, a lineage graph with a plurality of nodes and a plurality of provenance edges. The lineage graph creation component 12 uses the provenance information 16 to generate the lineage graph 18 with a plurality of nodes 20 and a plurality of provenance edges 22. The plurality of nodes 20 in the lineage graph 18 correspond to the plurality of machine learning models 14 and a provenance edge 22 between two nodes indicates a node is derived from another node.

In some implementations, each node of the plurality of nodes 20 includes a creation function 26. In some implementations, the lineage graph 18 includes a versioning edge 24 between nodes 20 in the lineage graph 18 with consecutive versions of a machine learning model 14.

In some implementations, the lineage graph 18 is automatically generated by the lineage graph creation component 12 by determining a structural difference between a two machine learning models; determining a contextual difference between the two machine learning models; and using the structural difference and the contextual difference to insert one of the two machine learning models into the lineage graph.

In some implementations, the lineage graph creation component 12 builds a diff primitive to determine the differences between two models. The diff primitive computes both structural (connectivity between layers of the model) and contextual (values of parameters in the model) differences between any two models (e.g., models A and B), and can be used across different model architectures since the diff primitive makes no assumptions on the underlying model type. In determining the diff primitive, the lineage graph creation component 12 first extracts a model's intermediate representation using symbolic tracing to obtain both models' directed acyclic graph (DAG) representations (a graph with directed edges and no directed cycles).

After obtaining both models' DAG representations, the lineage graph creation component 12 runs a hash-table based graph matching algorithm that produces the common and different layers and edges between models A and B.

An example graph matching algorithm used by the lineage graph creation component 12 to compute a diff primitive between the graph representations of two models is shown below in Algorithm 1.

Algorithm 1 - Graph Difference Algorithm

```
def module [symbol] diff(G1, G2):
  // G1 and G2 are DAG representations of the input
  // models. DAG nodes are torch nn.module layers,
  // (e.g., Linear, Conv20). An edge between two
  // nodes indicates dataflow.
  // We went to compute the diff, i.e., the nodes and
  // edges to remove and add to covert G1 and G2.
  // Compute hash tables of nodes/edges for G1 and G2
  // where values are node /edge lists sorted in
  // topological order. The hash of an edge is the
  // hash of its end points.
  N1, E1 = generate [symbol] hash [symbol] table(G1)
  N2, E2 = generate [symbol] hash [symbol] table(G2)
  // Iterate over E1, if a hash exists in E2,
  // greedily match each edge in two edge lists.
  // before deciding on a matching. check the nodes
  // in these edges and only commit when
  // corresponding nodes have the name matched
  // status. Matching a node in G1 with more than one
  // node in G2 is not allowed.
  Matches [symbol] N, Matches [symbol] E = { }, { }
  for hash in E1,
    es1 = E1[hash], es2 = E2[hash]
    for e1 in es1;
      for e2 in es2:
        if check(e1, e2):
          e1[0].matched, e1[1].matched = True, True
          e2[0].matched, e2[1],matched = True, True
          Matches [symbol] N.add((e1[0],e2[0]), (e1[1],e2(1]))
          Matches [symbol] E.add((e1,e2))
          E2[hash].drop(e2)
      es2 = E2[hash]
  // Match nodes that do not belong to common edges.
  for hash in N1:
    ns1 = [n1 in N1[hash] if n1.matched = False]
    ns2 = [n2 in N2[hash] if n2.matched = False]
    for i in range(min(len(ns1, ns2))):
          ns1[i].matched, ns2[i].matched = True, True
          Matches [symbol] N.add((ns1[i], ns2[i]))
  // Sort Matches [symbol] N/E by topological order of
  // nodes/edges in G1 and remove inverse
  // matches of node/edges. if n1 in G1 is matched
  // with an n2 in G2 after one of n1's preceding
  // nodes in G1 has been matched with a node that
  // appears later than the suggested n2
  // E.g., A-B-A-C and A-B-C-A should have a node
  // matching of only (A, B, C (or A)),
  Matches [symbol] N = filter(sort(Matches [symbol] N))
  Matches [symbol] E = filter(sort(Matches [symbol] E))
  // Add [symbol] N/E are the unmatched nodes/edges in G2.
  // Del [symbol] N/E are the unmatched nodes/edges in G1.
  Add [symbol] E = E2.difference(e2 in Matches [symbol] E)
  Del [symbol] E = E1.difference(e1 in Matches [symbol] E)
  Add [symbol] N = N2.difference(n2 in Matches [symbol] N)
  Del [symbol] N = N1.difference(n1 in Matches [symbol] N)
  return Add [symbol] E, Add [symbol] N, Del [symbol] E, Del [symbol] N [symbol]
indicates data missing or illegible when filed
```

The difference output contains the layers and edges to add and remove to produce model B from model A. In some implementations, the lineage graph creation component 12 computes structural and contextual differences by hashing either only the layer's attributes or also the parameter values.

Using the diff primitive, the lineage graph creation component 12 calculates two divergence scores d^{structural} and d^{contextual} based on the number of edges in the difference output between the two models A and B. Equation (1) illustrates an example equation that the lineage graph creation component 12 uses to determine the divergence structural score and equation (2) illustrates an example equation that the lineage graph creation component 12 uses to determine the divergence contextual score.

$${d}^{structual} = \frac{\vert {edges}_{diff}^{structural} \vert}{\vert {edges}_{A}^{structural} \vert + \vert {edges}_{B}^{structural} \vert} \qquad ( 1 )$$

$${d}^{contextual} = \frac{\vert {edges}_{diff}^{contextual} \vert}{\vert {edges}_{A}^{contextual} \vert + \vert {edges}_{B}^{contextual} \vert} \qquad ( 2 )$$

The lineage graph creation component 12 locates the latest inserted model in the lineage graph 18 that has the smallest contextual and structural divergence score; this node 20 is chosen as the parent of the to-be-inserted machine learning model 14. If no model is sufficiently contextually or structurally similar, the model will be added as a root of thelineage graph 18.

In some implementations, the lineage graph creation component 12 allows users to manually add children nodes to the lineage graph 18 and specify provenance information 16 for the children nodes. For example, the users use the lineage graph access tool 10 to manually add children nodes to the lineage graph 18.

In some implementations, the lineage graph creation component 12 receives a modification of the lineage graph 18 from a user using the lineage graph access tool 10 and the lineage graph creation component 12 updates the lineage graph 18 in response to the modification.

The method 300 is used to create a lineage graph 18 that helps track provenance information 16 across multiple machine learning models 14 in the form of provenance edges 22, and the creation functions 26 that can be used to re-create a machine learning model 14 given the machine learning model 14 checkpoints of its parents.

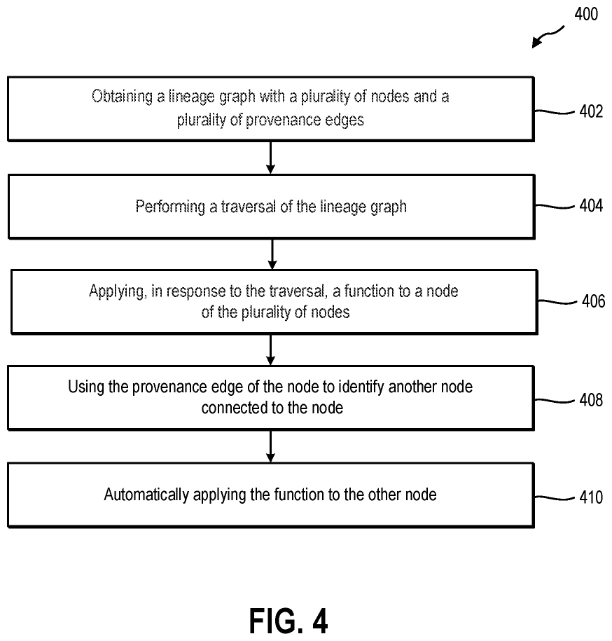

Referring now to FIG. 4, illustrated is an example method 400 for using the lineage graph to perform functions. The actions of the method 400 are discussed below with reference to FIGS. 1 and 2.

At 402, the method 400 includes obtaining a lineage graph with a plurality of nodes and a plurality of provenance edges. Each node of the plurality of nodes 20 corresponds to a machine learning model 14 and a provenance edge 22 between two nodes indicates a machine learning model 14 is derived from another machine learning model.

At 404, the method 400 includes performing a traversal of the lineage graph. In some implementations, the model update component 28 performs the traversal of the lineage graph 18. In some implementations, the model testing component 32 performs the traversal of the lineage graph 18. In some implementations, the traversal of the lineage graph 18 includes visiting nodes 20 of the lineage graph 18 in an arbitrary order in response to an identification of a type of edge (e.g., a provenance edge 22 or a versioning edge 24) to traverse. One example traversal is a breadth-first search (BFS). Another example traversal is a depth first search (DFS).

At 406, the method 400 includes applying, in response to the traversal, a function to a node of the plurality of nodes. In some implementations, the model testing component 32 applies a function 30 to a node 20 in the lineage graph 18 in response to receiving the action 38 from the lineage graph access tool 10.

At 408, the method 400 includes using the provenance edge of the node to identify another node connected to the node. In some implementations, the model testing component 32 performs the traversal of the lineage graph 18 using the provenance edge 22 to identify another node in the lineage graph 18 connected to the node 20. In some implementations, the model testing component 32 performs the traversal of the lineage graph 18 using a versioning edge 24 to identify another node in the lineage graph 18 connected to the node 20.

At 410, the method 400 includes automatically applying the function to the other node. In some implementations, the model testing component 32 automatically applies the function 30 to nodes with provenance edge connections to the node or the other node.

In some implementations, the model update component 28 automatically triggers the update cascade on downstream dependent machine learning models 14. For example, when a new version of a machine learning model 14 is created, the model update component 28 follows the provenance edges 22 in the lineage graph 18 to produce a new set of model versions for all of the machine learning model's 14 descendants. In some implementations, the model update component 28 uses a modified BFS traversal, where a node 20 is visited only once all of its parents have been visited, to ensure that the creation function 26 is called only when all arguments are available. For each node visited in the lineage graph 18 that should not be skipped, a new machine learning model is computed using the node's registered creation function 26.

An example algorithm the model update component 28 uses for machine learning model 14 updating is illustrated in algorithm (2).

Algorithm (2) - Machine Learning Model Updating

```
def run [symbol] update [symbol] cascade(m, m′ , skip [symbol] fn, terminate [symbol] fn);
  // First, create (empty) next versions of models.
  skip [symbol] fn2 = lambda x: skip [symbol] fn(x) or x = = m
  for x in BF5(m, skip [symbol] fn2, terminate [symbol] fn):
    // Get next version of each parent of x if it
    // exists, otherwise get current version.
    ps′ = [get [symbol] next [symbol] version(p) for p in x.parents]
    x′ = x.cr.intitalize(ps′ )
    // Add provenance and version edges, and copy
    // creation function.
    add [symbol] edges(p′, x′) for p′ in ps′
    add [symbol] version_edges(x, x′)
    x′.cr = x.cr
  // Next, start traversal at children of m′, and
  // train models by calling creation function.
  // traversal [symbol] all [symbol] parents [symbol] first returns an
  // interator over nodes (or group of nodes if
  // using MTL) such that a node is visited only
  // once [symbol] all [symbol]  of its parents (parent MTL groups
  // if using MTL) are visited.
  skip [symbol] fn2 = lambda x; skip [symbol] fn(x) or x == m′
  for xs′ in traversal [symbol] all [symbol] parents [symbol] first(m′, skip [symbol] fn2
        , term [symbol] fn);
    if isinstance(xs′, list):
      // Run MTL using combined creation function.
      // creation functions.
      merged [symbol] cr(xs′, xs′.parents)
    else:
      // Otherwise, call individual model node′s
      // creation function.
      [x′] = xs′
      x′.cr(x′.parents) [symbol]
indicates data missing or illegible when filed
```

In some implementations, the model update component 28 uses multi-task learning (MTL) to continuously share parameters across machine learning models 14 even across updates by using an appropriate creation function 26. The traversal to retrain machine learning models 14 needs to ensure that full MTL groups are executed only once all MTL groups on which they depend also complete. Additionally, individual creation functions 26 are not called for the nodes 20. Instead, the desired creation functions 26 are merged into a merged creation function that returns n new machine learning models. The merged creation function ensures that weights are appropriately shared, and appropriate loss functions are used. The model update component 28 uses the merged creation function to update the machine learning models 14 associated with the nodes 20.

In some implementations, the function 30 is debugging the machine learning model of the node. The model update component 28 debugs the machine learning model 14 of the node 20. The model update component 28 automatically provides any updates from the debugging process of the machine learning model 14 on downstream dependent machine learning models in the lineage graph 18 of the node 20.

In some implementations, users specify the machine learning model 14 that has been updated using the lineage graph access tool 10 and model update component 28 automatically triggers the update cascade on downstream models in the lineage graph 18 in response to the users specifying the update that occurred for the machine learning model 14.

In some implementations, the function 30 is applying a test to the machine learning model of the node. In some implementations, model testing component 32 applies a test identified (e.g., by name or type) to a specific machine learning model 14 associated with a node 20 of the lineage graph 18 or for machine learning models 14 of a specified type associated with the nodes 20 of the lineage graph 18.

In some implementations, the function 30 runs diagnosis on the machine learning models. For example, a diagnostic could be computing the deltas between every machine leaming model 14 and its parent(s) or measuring the sparsity levels of various machine learning models 14.

The method 400 uses the lineage graph 18 to facilitate traversals of the lineage graph 18 and applying one or more functions 30 on the machine learning models 14 of the lineage graph 18 in response to the traversals of the lineage graph 18.

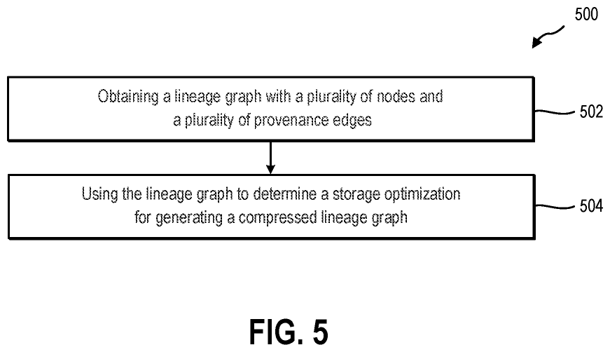

Referring now to FIG. 5, illustrated is an example method 500 for using the lineage graph to perform storage optimizations. The actions of the method 500 are discussed below with reference to FIGS. 1 and 2.

At 502, the method 500 includes obtaining a lineage graph with a plurality of nodes and a plurality of provenance edges. Each node 20 of the plurality of nodes corresponds to a machine learning model 14 and a provenance edge 22 between two nodes 20 indicates a machine learning model 14 is derived from another machine learning model.

At 504, the method 500 includes using the lineage graph to determine a storage optimization for generating a compressed lineage graph. The storage optimization component 34 uses the lineage graph 18 to determine a storage optimization for generating a compressed lineage graph 36. The compressed lineage graph 36 reduces the storage footprint for a plurality of machine learning models represented in the lineage graph 18. A lineage graph 18 with multiple related machine learning models may have redundancy in the actual parameters of the machine learning models 14 of the lineage graph 18. The storage optimization component 34 determines storage optimizations to more efficiently store the machine learning models 14 of the lineage graph 18.

In some implementations, the storage optimization is content-based hashing. Many derived machine learning models can share parameters. To not redundantly store duplicate copies of these parameters, the storage optimization component 34 uses content-based hashing to reduce the storage of the lineage graph 18. The storage optimization component 34 manages a global hash table for storing the parameters of all machine learning models 14 in a lineage graph 18. The SHA-256 hash of each parameter is calculated using both the values of the under-lying tensor and its shape.

In some implementations, the storage optimization is a delta compression. The storage optimization component 34 uses delta compression as the storage optimization for the lineage graph 18. The non-identical parameters of parent and child models in the lineage graph 18 may only differ slightly, motivating the storage optimization component 34 to use compression and decompression of the parameter deltas between machine learning models 14 in the lineage graph 18, which may be sparse for similar machine learning models, for additional space savings.

One challenge in compressing deltas in the lineage graph 18 is the fact that parent and child machine learning models 14 in the lineage graph 18 may not have identical architectures. The storage optimization component 34 runs a longest common subsequence algorithm to compute a mapping between parameters of the model that have the same shape in response to the user specifying a node to be delta compressible. For models with the same architecture, running the longest common subsequence algorithm will reduce to parameters of corresponding layers matching witheach other.

Given a mapping between parameters p₁ and p₂ of the two models, the storage optimization component 34 first computes the delta Δp between each pair of parameters and then quantizes the delta.

An example equation the storage optimization component 34 uses is illustrated below in equation (3).

$$Δ p = {p}_{1} - {p}_{2} \qquad ( 3 )$$

$$Δ {p}^{quantized} = \frac{Δ p}{2 \cdot log ( 1 + ϵ )} + 0.5$$

The storage optimization component 34 uses a compressor and a decompressor module to losslessly compress each of these quantized deltas Δp^{quantized}. After compression, the storage optimization component 34 accepts the delta compression if the compression results in storage saving and compression does not result in an accuracy drop. Each delta compressed parameter is stored on the datastore 108 (FIG. 1) as the compressed delta along with a pointer to the parent layer to facilitate future decompression (e.g., the compressed lineage graph 36). If not, compression is rejected, and the uncompressed model is persisted in the datastore 108 (e.g., the lineage graph 18).

An example algorithm that the storage optimization component 34 uses for delta compression is illustrated in algorithm (3).

Algorithm 3 - Delta Compression

```
def delta [symbol] .compression(m2, m1, t [symbol] thr):
  // m1 and m2 are the parent and child models.
  // We want to compress m1 · m2.
  // t [symbol] thr is a user-configurable test accuracy
  // threshold. If the model after compression
  // has an accuracy difference from m1 larger than
  // t [symbol] thr, model compression is rejected.
  // First, run LCS to find a mapping between
  // parameters of the same shape.
  (P1, P2) = lcs(m1, m2)
  // Calculate quantized deltas between two
  // parameter sets.
  D = quantize(P1, P2)
  // Compressor performs lossless compression.
  // Possible options are RLE, LZMA, etc.
  CD, storage [symbol] saving = compressor(D)
  if storage [symbol] saving < 1:
    return False, None, m2
  else:
    P2′ = dequantize(D, P1)
    // Restore parameters that are not compressed.
    m2′ = m2.difference(P2).union(P2′)
    if run [symbol] tests([m2′]) · run [symbol] tests([m2]) < t [symbol] thr:
      return False, None, m2
    else:
      return True, CD, m2′ [symbol]
indicates data missing or illegible when filed
```

In some implementations, the storage optimization component 34 applies the storage optimization recursively to the lineage graph 18. That is, the storage optimization component 34 computes the delta between the layers of a child model and a parent model that is itself delta compressed and loading a model instance is recursively decompressed up the compression chain until the first ancestor node that is not delta compressed.

The method 500 determines storage optimizations to more efficiently store the machine learning models 14 of the lineage graph 18, making it more practical to store a number of dependent machine learning models in the lineage graph 18, allowing users to also store more machine learning models 14, making it unnecessary to manually garbage collect model checkpoints to save on disk space.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Instructions and data may be stored in the memory. The instructions may be executable by the processor to implement some or all of the functionality disclosed herein. Executing the instructions may involve the use of the data that is stored in the memory in electronic communication with the processor. The memory may be any electronic component capable of storing electronic information. For example, the memory may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
identifying a plurality of machine learning models;
determining provenance information for each machine learning model of the plurality of machine learning models; and
generating, using the provenance information, a lineage graph with a plurality of nodes and a plurality of provenance edges, wherein the plurality of nodes correspond to the plurality of machine learning models and a provenance edge between two nodes indicates a node is derived from another node.

2. The method of claim 1, wherein the plurality of machine learning models include machine learning model derivatives that depend on another machine learning model.

3. The method of claim 1, wherein the provenance information provides parent information of machine learning models that were used in creating each machine learning model.

4. The method of claim 1, wherein each node of the plurality of nodes includes a creation function that identifies how each machine learning model is created.

5. The method of claim 1, wherein the lineage graph further includes:
a versioning edge between nodes in the lineage graph with consecutive versions of a machine learning model.

6. The method of claim 1, wherein the lineage graph is automatically generated by:
determining a structural difference between two machine learning models;
determining a contextual difference between the two machine learning models; and
using the structural difference and the contextual difference to insert one of the two machine learning models into the lineage graph.

7. The method of claim 6, further comprising:
receiving a modification of the lineage graph from a user; and
updating the lineage graph in response to the modification.

8. A method, comprising:
obtaining a lineage graph with a plurality of nodes and a plurality of provenance edges, wherein each node of the plurality of nodes corresponds to a machine learning model and a provenance edge between two nodes indicates a machine learning model is derived from another machine learning model;
performing a traversal of the lineage graph;
applying, in response to the traversal, a function to a node of the plurality of nodes;
using the provenance edge of the node to identify another node connected to the node; and
automatically applying the function to the other node.

9. The method of claim 8, wherein the traversal of the lineage graph includes visiting nodes of the lineage graph in an arbitrary order in response to an identification of a type of edge to traverse.

10. The method of claim 8, wherein the function is debugging the machine learning model of the node.

11. The method of claim 8, wherein the function is a modification to the machine learning model of the node.

12. The method of claim 8, wherein the function is applying a test to the machine learning model of the node.

13. The method of claim 8, wherein the function runs diagnosis on machine learning models.

14. The method of claim 13, wherein the diagnosis includes measuring sparsity levels of the machine learning models or computing deltas between the machine learning models.

15. A method, comprising:
obtaining a lineage graph with a plurality of nodes and a plurality of provenance edges, wherein each node of the plurality of nodes corresponds to a machine learning model and a provenance edge between two nodes indicates a machine learning model is derived from another machine learning model; and
using the lineage graph to determine a storage optimization for generating a compressed lineage graph.

16. The method of claim 15, wherein the compressed lineage graph reduces a storage footprint for a plurality of machine learning models represented in the lineage graph.

17. The method of claim 15, wherein the storage optimization is recursively applied to the lineage graph.

18. The method of claim 15, wherein the lineage graph provides provenance information for the plurality of nodes in the lineage graph with parent information of each machine learning model associated with the plurality of nodes.

19. The method of claim 15, wherein the storage optimization is content-based hashing.

20. The method of claim 15, wherein the storage optimization is delta compression.
